(19) United States
(12) Patent Application Publication
(10) Pub. No.: US 2007/0181501 A1
(43) Pub. Date: Aug. 9, 2007

(54) Method and apparatus for packing chromatography column

(75) Inventors: Bernd-Walter Hoffmann, Karlsruhe (DE); Brian A. Bidlingmeyer, Frazer, PA (US); Alan D. Broske, West Chester, PA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: Agilent Technologies, Inc., Palo Alto, CA (US)

(21) Appl. No.: 11/349,560

(22) Filed: Feb. 8, 2006

(51) Int. Cl. B01D 15/08

(52) U.S. Cl. 210/656; 210/198.2; 73/61.52; 73/61.53

(57) ABSTRACT

An apparatus for packing a chromatography column with a granular packing medium is disclosed. The apparatus includes a chamber adapted to hold a mixture of the packing medium and a liquid. The chamber is in fluid communication with a pump and the column. A vibrator is positioned so as to agitate the mixture within the chamber. The invention also includes a method of packing the chromatography column by forming a mixture comprising the packing medium and the liquid, positioning the mixture within the chamber, agitating the mixture, and pumping liquid into the chamber thereby forcing the mixture through the column.

### BACKGROUND

High performance liquid chromatography (HPLC) is a process by which one or more compounds from a chemical mixture may be separated and identified. Chromatography columns are used for any type of separation where a sample is loaded and eluted from the column in order to obtain separation of one or more components. Examples include analysis columns for identifying constituents, preparation columns for separating constituents prior to analysis and guard columns which protect analysis columns by separating out impurities before they can contaminate the analysis column.

In a particular example of an analysis column, a transport liquid, such as a solvent, is pumped under high pressure through a column of packing medium, and a sample of the chemical mixture to be analyzed is injected into the column. As the sample passes through the column with the liquid, the different compounds, each one having a different affinity for the packing medium, move through the column at different speeds. Those compounds having greater affinity for the packing medium move more slowly through the column than those having less affinity, and this speed differential results in the compounds being separated from one another as they pass through the column.

The transport liquid with the separated compounds exits the column and passes through a detector, which identifies the molecules, for example by spectrophotometric absorbance measurements. A two dimensional plot of the detector measurements against elution time or volume, known as a chromatogram, may be made, and from the chromatogram the compounds may be identified.

For each compound, the chromatogram displays a separate curve or “peak”. Effective separation of the compounds by the column is advantageous because it provides for measurements yielding well defined peaks having sharp maxima inflection points and narrow base widths, allowing excellent resolution and reliable identification of the mixture constituents. Broad peaks, caused by poor column performance, are undesirable as they may allow minor components of the mixture to be masked by major components and go unidentified.

Columns for HPLC are packed with packing media comprising, for example, silica spheres having a diameter between 0.5 to 50 microns or between 1 to 10 microns or even 1 to 7 microns. The uniformity of the packing medium within the column has a significant effect on column performance. It is desired that the particles comprising the packing medium be substantially uniformly arranged and as homogeneous as practicable so that the transport liquid and the sample mixture move at uniform rates through the column. Areas of loose packing medium create channels causing locally increased flow rates while areas that are partially plugged due to particle aggregation create eddies that retard the flow. Such local variations in the flow rate caused by non-uniform packing medium result in transport liquid mixing that degrades the column performance resulting in broadening of the peaks and a concomitant decrease the resolving capability of the separation process. It would be advantageous to increase the uniformity and homogeneity of the packing medium in chromatography columns to ensure adequate column performance and increased column life.

### SUMMARY

The invention concerns an apparatus for packing a chromatography column with a granular packing medium. The apparatus is adapted for use with a pump for pumping a liquid. The apparatus comprises a chamber adapted to hold a mixture of the packing medium and the liquid. The chamber is in fluid communication with the pump and the column. A vibrator is positioned so as to agitate the mixture within the chamber. The liquid is pumped into the chamber. The mixture within the chamber is thereby forced through the column. The vibrator agitates the mixture within the chamber to provide a substantially uniform distribution of the packing medium throughout the liquid. The packing medium is retained within the column.

The invention also includes a method of packing a chromatography column with a granular packing medium carried by a liquid. The method comprises:
forming a mixture comprising the packing medium and the liquid;
positioning the mixture within a chamber in fluid communication with the column;
agitating the mixture within the chamber;
pumping the liquid into the chamber thereby forcing the mixture through the column, the packing medium being retained within the column.

### BRIEF DESCRIPTION OF THE DRAWING

FIG. 1 is a schematic diagram illustrating an embodiment of an apparatus according to the invention.

### DETAILED DESCRIPTION

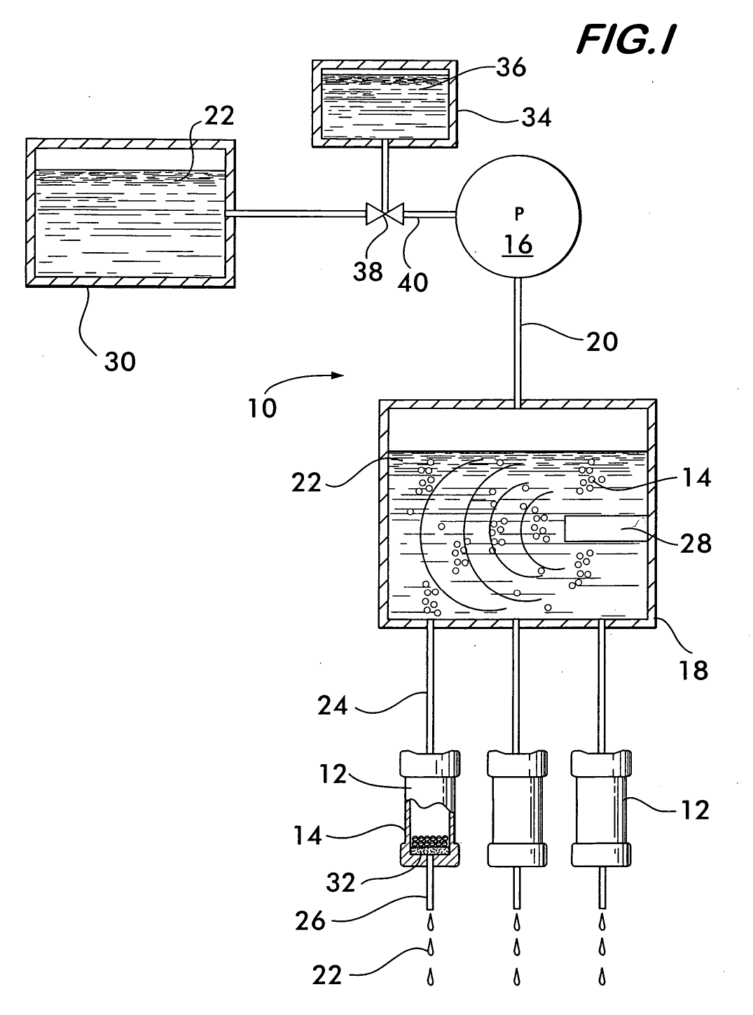

FIG. 1 shows an embodiment of an apparatus 10 for packing one or more chromatographic columns 12 with a granular packing medium 14. The apparatus comprises a pump 16 in fluid communication with a chamber 18 through a delivery conduit 20. Chamber 18 contains a mixture of packing medium 14 and a transport liquid 22. The packing medium may comprise, for example, silica particles having diameters between 5 and 50 microns or 10 to 30 microns or even 15 to 20 microns. The particle content of the mixture may range between 1% and 50% by weight. In a typical embodiment, the transport liquid is chosen so that its density is close to that of the packing medium so that the particles of packing medium are substantially neutrally buoyant in the mixture and remain suspended substantially uniformly throughout the liquid. The transport liquid may comprise, for example, organic solvents such as methanol and water or water alone. The substantially uniform suspension of the packing medium facilitates uniform and homogeneous packing of the packing medium to create a stable bed of packing medium within the initially empty tube, columns 12. A stable bed is advantageous because the packing medium will be less likely to shift under pressure when in use and form regions of greater or lesser density that adversely affect column performance.

Columns 12 are in fluid communication with chamber 18, for example through respective feeder conduits 24. Transport liquid 22 exits the columns through drain conduits 26, the liquid being discarded or collected for eventual reuse.

A vibrator 28 is used to agitate the mixture of packing medium 14 and transport liquid 22 within chamber 18. Preferably the vibrator is positioned within the chamber and operates in the ultrasonic range of frequencies above 20,000 Hertz. Operating frequencies as great as 40,000 Hertz may be used. Agitation by the vibrator 28 helps to maintain the mixture in a homogeneous state during packing of the columns to facilitate the formation of uniform beds of packing medium for improved column performance.

Pump 16 is preferably a liquid chromatography pump that operates at pressures as great as 2,000 bar and flow rates smaller than about 1 ml/min up to about 20 ml/min similar to those used during chromatographic analysis. For practical applications chamber 18 may have a volume of between 0.1 and 2 liters depending upon the volume and number of columns 12 to be packed. Chamber 18 as well as the delivery, feeder and drain conduits 20, 24 and 26 and the various fittings (not shown) required to effect fluid-tight connections between the components and the conduits are preferably made of stainless steel. Stainless steel provides the strength required to withstand the high pressures at which the apparatus 10 operates and is also substantially inert and therefore will not corrode or contaminate the mixture of transport liquid and packing medium.

The system parameters such as pump pressure and flow rate, chamber volume and the power of the vibrator are tailored to the types of columns to be packed. Columns 12 could be any type of liquid chromatography column, including: capillary columns, which may have an inner diameter between 0.02 to 0.5 mm or 0.1 to 0.3 mm or even 0.3 to 0.5 mm, and lengths between 5 mm and 3000 mm or 15 to 500 mm or 20 to 300 mm; analytical columns having inner diameters between 1 and 10 mm or 1 to 7 mm or 5 to 6 mm, and lengths between 10 and 500 mm or 10 to 300 mm or 20 to 250 mm; preparatory columns having inner diameters between 10 and 50 mm or 20 to 40 mm or even between 25 to 35 mm, and lengths between 20 and 250 mm, or 50 to 150 mm or even 75 to 100 mm; and guard columns having inner diameters between 1 and 10 mm or 1 to 7 mm or 5 to 6 mm, and lengths between 4 and 20 mm or 5 to 15 mm or even 5-13 mm.

In operation of the apparatus 10, the chamber 18 is filled with a mixture of transport liquid 22 and packing medium 14. Vibrator 28 is used to agitate the mixture and keep the particles in suspension to provide a substantially uniform mixture density throughout the chamber. Uniform mixture density means that there is no significant gradient of the particle distribution throughout the chamber as would occur if there was no agitation. For example, without agitation of the mixture by the vibrator the particles would tend to settle under gravity and one would find more particles per unit volume as a function of depth in the chamber. The agitation promotes uniformity of particle density so that regardless at what depth in the chamber the liquid was sampled there would be the same number of particles per unit volume.

Pump 16 pumps transport liquid 22 from a reservoir 30 into the chamber 18 through delivery conduit 20. The mixture is hydraulically forced into the various columns 12 through the respective feeder conduits 24. A porous element 32 is positioned at the downstream end of each column. The porous element has pores sized to allow the transport liquid to pass while retaining the packing medium within the column. The porous element may comprise a membrane, a screen, or a stainless steel or plastic frit depending upon the size of the packing medium being used and the pressure under which the columns are packed. Transport liquid 22 exits the columns 12 through drain conduits 26 and may be discarded or recycled.

The configuration of apparatus 10 allows additional reservoirs 34 holding other transport liquid 36 to be used. Preferably flow from the multiple reservoirs to pump 16 is controlled by a valve 38 positioned within a supply conduit 40 that provides fluid communication between the reservoirs 30 and 34 and pump 16. The valve 38 selectively controls which of the different transport liquids are to be used as desired. For example, it may be advantageous to first use liquid 22 from reservoir 30 to pack the columns 12, and then, once they are packed, halt the flow of liquid 22 and pump liquid 36 from reservoir 34 into chamber 18 to flush the columns. This is advantageous, for example, if liquid 22 is a volatile substance which should not remain in the columns after packing. Effective flushing of the columns is achieved by passing a volume of flushing liquid 36 through the columns that is 3-5 times greater than the amount of packing liquid 22 used to pack the columns. It is advantageous to cease agitating the liquid within chamber 18 during flushing of the columns in order to minimize the potential for disturbing the packing medium within the columns 12.

The embodiment described herein is by way of example only, and further embodiments incorporating additional elements, such as a heating element for controlling the temperature of the transport liquid, or additional valves to mitigate pressure slamming, are also feasible.

What is claimed is:

1. An apparatus for packing a chromatography column with a granular packing medium using a transport liquid, said apparatus comprising:
a chamber adapted to hold a mixture of said packing medium and said liquid, said chamber being in fluid communication with said column;
a vibrator positioned so as to agitate said mixture within said chamber; and
a pump in fluid communication with said chamber to pump said liquid from said chamber into said column.

2. An Apparatus according to claim 1, wherein said vibrator agitates said mixture within said chamber to provide a substantially uniform distribution of said packing medium throughout said liquid.

3. An apparatus according to claim 1, wherein said chamber is in fluid communication with a plurality of said chromatography columns.

4. An apparatus according to claim 1, wherein said vibrator operates at a frequency above 20,000 Hertz.

5. An apparatus according to claim 1, wherein said vibrator operates at one or more frequencies between 20,000 Hertz and 40,000 Hertz.

6. An apparatus according to claim 1, wherein said vibrator is positioned within said chamber.

7. An apparatus according to claim 1, further comprising:
a first reservoir adapted to contain said liquid;
a second reservoir adapted to contain another liquid;
a valve in fluid communication with said first and second reservoirs, said valve being in fluid communication with said pump, said valve selectively controlling flow of said liquids from said first and second reservoirs to said pump.

8. An apparatus for packing a chromatography column with a granular packing medium by passing a liquid carrying said packing medium through said column, said apparatus comprising:
a pump for pumping said liquid;
a chamber adapted to hold a mixture comprising said packing medium and said liquid;
a first conduit providing fluid communication between said pump and said chamber;
a second conduit providing fluid communication between said chamber and said column;
a vibrator positioned so as to agitate said mixture within said chamber; and wherein
said liquid is pumped into said chamber, said mixture within said chamber being thereby forced through said column, said vibrator agitating said mixture within said chamber to provide a substantially uniform distribution of said packing medium throughout said liquid, said packing medium being retained within said column.

9. An apparatus according to claim 8, further comprising a plurality of second conduits for simultaneous fluid communication with a plurality of said chromatography columns.

10. An apparatus according to claim 8, wherein said vibrator operates at a frequency above 20,000 Hertz.

11. An apparatus according to claim 8, wherein said vibrator operates at one or more frequencies between 20,000 Hertz and 40,000 Hertz.

12. An apparatus according to claim 8, wherein said vibrator is positioned within said chamber.

13. An apparatus according to claim 8, further comprising:
first and second reservoirs holding first and second said liquids;
a supply conduit providing fluid communication between said first and second reservoirs and said pump;
a valve positioned in said supply conduit for selectively controlling flow from said first and second reservoirs to said pump.

14. A method of packing a chromatography column with a granular packing medium carried by a liquid, said method comprising:
forming a mixture comprising said packing medium and said liquid;
positioning said mixture within a chamber in fluid communication with said column;
agitating said mixture within said chamber;
pumping said liquid into said chamber thereby forcing said mixture through said column, said packing medium being retained within said column.

15. A method according to claim 14, comprising agitating said mixture by vibrations at a frequency greater than 20,000 Hertz.

16. A method according to claim 14, comprising agitating said mixture by vibrations between 20,000 Hertz and 40,000 Hertz.

17. A method according to claim 14, further comprising:
providing another liquid;
ceasing agitation of said liquid within said chamber; and
pumping said other liquid into said chamber and through said column.
